(19) United States
(12) Patent Application Publication
(10) Pub. No.: US 2009/0067661 A1
(43) Pub. Date: Mar. 12, 2009

(54) DEVICE AND METHOD FOR REMOTE ACOUSTIC PORTING AND MAGNETIC ACOUSTIC CONNECTION

(75) Inventors: John P. Keady, Boca Raton, FL (US); Robert Schulein, Schaumburg, IL (US)

Correspondence Address: PERSONICS HOLDINGS INC., 5100 Town Center Circle, Tower 11, Suite 510, BOCA RATON, FL, 33486, US

(73) Assignee: Personics Holdings Inc., Boca Raton, FL (US)

(21) Appl. No.: 12/176,496

(22) Filed: Jul. 21, 2008

Related U.S. Application Data
(60) Provisional application No. 60/950,864, filed on Jul. 19, 2007.

(51) Int. Cl. H04R 25/00

(52) U.S. Cl. 381/375

(57) ABSTRACT

An earpiece device includes a microphone and a speaker having a common acoustic channel to reduce complexity and minimize components in an ear canal region. The earpiece device also includes a logic circuit operatively connected into an earpiece, where the microphone is configured to sample an acoustic signal traveling from either end of an acoustic channel. The earpiece device further includes a selective attenuation mechanism for varying the acoustic energy from one end of the acoustic channel or combining the acoustic energies in a controlled ratio from both ends of the acoustic channel before reaching the microphone.

### CROSS-REFERENCE TO RELATED APPLICATIONS

This application claims the benefit of U.S. provisional patent application No. 60/950,864 filed on 19 Jul. 2007. The disclosure of which is incorporated herein by reference in its entirety.

### FIELD OF THE INVENTION

The invention relates in general to devices and methods of earpiece configuration, and particularly though not exclusively, is related to an earpiece using an acoustic channel to receive an acoustic signal and deliver an acoustic signal.

### BACKGROUND OF THE INVENTION

Present day ear devices are intended to deliver information to the ear via off-the-shelf or custom-molded pieces that present the information primarily in the outer third of the ear canal, often with questionable attention to the actual fit, comfort, and consideration of the ear anatomy and physiology.

Additionally, in other earpiece designs, a transducer is suspended over the ear canal opening. Ambient sound from the surrounding environment enters the ear canal with the audio content from the transducer. Environmental sounds such as traffic, construction, and nearby conversations can degrade the quality of the communication experience. It can be difficult to communicate using an earpiece or earphone device in the presence of high-level background sounds.

Although audio processing technologies can suppress some noise, the earpiece is generally sound agnostic and cannot differentiate sounds. Thus, one method to prevent ambient sound from entering the ear is to seal or provide an acoustic barrier at the opening of the ear canal. Sealing ensures minimum background noise entering the ear canal under high background noise conditions. Earpiece systems may require some minimum noise isolation from the ambient to provide adequate performance to the user.

### SUMMARY OF THE INVENTION

At least one exemplary embodiment is related to an earpiece (e.g., earphone, earbud, or other devices configured to direct acoustic signals to the ear) inserted into the ear canal, where a microphone and a speaker share a common acoustic channel a distance down the acoustic channels.

In yet at least one other exemplary embodiment the acoustic energy from a receiver is directed via an acoustic channel from or near the aperture of the ear canal to a position closer to the ear drum, likewise a microphone measures acoustic energy from a region near the ear drum, where the acoustic energy is channeled via an acoustic channel to the microphone.

At least one further exemplary embodiment is directed to an earpiece that uses one microphone to acoustically sample between an ambient region and an ear canal of the user. This is achieved by blocking or partially blocking the acoustic channel to receive acoustic energy from either the ear canal of the user or the ambient region outside the ear.

At least one further exemplary embodiment uses magnetic fields to couple detachable acoustic lines to an earpiece.

Further areas of applicability of embodiments of the present invention will become apparent from the detailed description provided hereinafter. It should be understood that the detailed description and specific examples, while indicating exemplary embodiments of the invention, are intended for purposes of illustration only and are not intended to limit the scope of the invention.

### BRIEF DESCRIPTION OF THE DRAWINGS

Exemplary embodiments of the present invention will become apparent from the following detailed description taken in conjunction with the following drawings.

FIG. 1 illustrates an earpiece in accordance with at least one exemplary embodiment;

FIG. 2 is a block diagram of circuitry and components of an earpiece in accordance with at least one exemplary embodiment;

FIG. 3 illustrates an example of a common acoustic channel for an Ear Canal Receiver and an Ear Canal Microphone in an earpiece;

FIG. 4 illustrates a single transducer coupled to an acoustic channel having three ports, thus sampling either the ambient environment or the ear canal environment;

FIG. 5 is a cross-section of an acoustic channel with a mems actuator in accordance with at least one exemplary embodiment;

FIG. 6 is a cross-section showing the mems actuator partially blocking the acoustic channel in accordance with at least one exemplary embodiment;

FIG. 7 is a cross-section showing the mems actuator fully blocking the acoustic channel in accordance with at least one exemplary embodiment;

FIG. 8 is a cross-section of an acoustic channel and a blocking mechanism in accordance with at least one exemplary embodiment;

FIG. 9 is an illustration of an exemplary embodiment of a battery replacement module of an earpiece; and

FIG. 10 is a cross-section of the battery replacement module.

### DETAILED DESCRIPTION OF EXEMPLARY EMBODIMENTS OF THE PRESENT INVENTION

The following description of exemplary embodiment(s) is merely illustrative in nature and is in no way intended to limit the invention, its application, or uses.

Exemplary embodiments are directed to or can be operatively used on various wired or wireless earpieces devices (e.g., earbuds, headphones, ear terminal, behind the ear devices or other acoustic devices as known by one of ordinary skill, and equivalents).

Processes, techniques, apparatus, and materials as known by one of ordinary skill in the art may not be discussed in detail but are intended to be part of the enabling description where appropriate. For example specific computer code may not be listed for achieving each of the steps discussed, however one of ordinary skill would be able, without undo experimentation, to write such code given the enabling disclosure herein. Such code is intended to fall within the scope of at least one exemplary embodiment.

Additionally exemplary embodiments are not limited to earpieces, for example some functionality can be implemented on other systems with speakers and/or microphones for example computer systems, PDAs, Blackberrys, cell and mobile phones, and any other device that emits or measures acoustic energy. Additionally, exemplary embodiments can be used with digital and non-digital acoustic systems. Additionally various receivers and microphones can be used, for example MEMs transducers, diaphragm transducers, for examples Knowle's FG and EG series transducers.

Notice that similar reference numerals and letters refer to similar items in the following figures, and thus once an item is defined in one figure, it may not be discussed or further defined in the following figures.

In all of the examples illustrated and discussed herein, any specific values, for example the sound pressure level change, should be interpreted to be illustrative only and non-limiting. Thus, other examples of the exemplary embodiments could have different values.

Note that herein when referring to correcting or preventing an error or damage (e.g., hearing damage), a reduction of the damage or error and/or a correction of the damage or error are intended.

Processes, methods, materials and devices known by one of ordinary skill in the relevant arts may not be discussed in detail but are intended to be part of the enabling discussion where appropriate. For example an example is provided using a MEMS actuator to close off the acoustic channel at certain portions, however any type of mechanism automated or user selected, as known by one of ordinary skill in the relevant art, can be used to selectively close off portions of the acoustic channel.

Additionally, the size of structures used in exemplary embodiments are not limited by any discussion herein (e.g., the sizes of structures can be macro (centimeter, meter), micro (micro meter), nanometer size and smaller). For example although many of the figures may not contain dimensions, one of ordinary skill would realize that the core structure of the devices can be dimensioned to conform with a minimal cross-section to fit the majority of ear canal sizes.

At least one exemplary embodiment of the invention is directed to an earpiece that directs acoustic energy into the ear canal and samples acoustic energy from the ear canal. Reference is made to FIG. 1 in which an earpiece device, generally indicated as earpiece 90, is constructed and operates in accordance with at least one exemplary embodiment of the invention. As illustrated, earpiece 90 comprises an electronic housing unit 100 and a sealing unit 108. Earpiece 90 depicts an electro-acoustical assembly for an in-the-ear acoustic assembly, as it would typically be placed in an ear canal 124 of a user 130. The earpiece 90 can be an in the ear earpiece, behind the ear earpiece, receiver in the ear, partial-fit device, or any other suitable earpiece type. The earpiece 90 can be partially or fully occluded in ear canal 124, and is suitable for use with users having healthy or abnormal auditory functioning.

In one exemplary embodiment, earpiece 90 includes an Ambient Sound Microphone (ASM) 120 to capture (measure) ambient sound (acoustic energy), an Ear Canal Receiver (ECR) 114 to deliver audio (acoustic energy) to an ear canal 124, and an Ear Canal Microphone (ECM) 106 to capture and assess a sound exposure level within the ear canal 124. The earpiece 90 can partially or fully occlude the ear canal 124 to provide various degrees of acoustic isolation. The assembly is designed to be inserted into the user's ear canal 124, and to form an acoustic seal with the walls of the ear canal 124 at a location between the entrance to the ear canal 124 and the tympanic membrane (or ear drum). In general, such a seal is typically achieved by means of a soft and compliant housing of sealing unit 108.

Sealing unit 108 can be an acoustic barrier (e.g., producing acoustic isolation or reducing acoustic energy across the sealing unit), having a first side coupled to ear canal 124 and a second side coupled to the ambient region or ambient environment. In at least one exemplary embodiment, sealing unit 108 includes at least one acoustic tube. The at least one acoustic tube is an acoustic pathway for receiving or delivering audio content. Sealing unit 108 can create a closed cavity of (e.g., approximately 5 cc) between the first side of sealing unit 108 and the tympanic membrane in ear canal 124. As a result of this sealing, the ECR (speaker) 114 is able to generate a full range bass response when reproducing sounds for the user. This seal also serves to significantly reduce the sound pressure level at the user's eardrum resulting from the sound field at the entrance to the ear canal 124. This seal is also a basis for a passive sound isolating performance of the electro-acoustic assembly.

In at least one exemplary embodiment and in broader context, the second side of sealing unit 108 corresponds to earpiece 90, and is operatively connected to electronic housing unit 100, and ambient sound microphone 120 that is exposed to the ambient environment. Ambient sound microphone 120 receives ambient sound from the ambient region around the user.

Electronic housing unit 100 houses system components such as a microprocessor 116, memory 104, battery 102, ECM 106, ASM 120, ECR, 114, and user interface 120. Microprocessor 116 can be a logic circuit, a digital signal processor, controller, or the like for performing calculations and operations for earpiece 90. Microprocessor 116 is operatively coupled to memory 104, ECM 106, ASM 120, ECR 114, and user interface 120. A wire 118 provides an external connection to earpiece 90. Battery 102 powers the circuits and transducers of earpiece 90. Battery 102 can be a rechargeable or replaceable battery.

One function of ECM 106 is that of measuring the sound pressure level in the ear canal cavity 124 as a part of testing the hearing acuity of the user as well as confirming the integrity of the acoustic seal and the working condition of the earpiece 90. In one arrangement, ASM 120 is housed in an ear seal of earpiece 90 to monitor sound pressure at the entrance to the occluded or partially occluded ear canal 124. All transducers shown can receive or transmit audio electrical signals to microprocessor 116 (hereinafter processor 116) that undertakes audio signal processing and provides a transceiver for audio via the wired (wire 118) or a wireless communication path.

In at least one exemplary embodiment, earpiece 90 can actively monitor a sound pressure level both inside and outside an ear canal 124 and enhance spatial and timbral sound quality while maintaining supervision to ensure safe sound reproduction levels. The earpiece 90 in various embodiments can conduct listening tests, filter sounds in the environment, monitor warning sounds in the environment, present notification based on identified warning sounds, maintain constant audio content to ambient sound levels, and filter sound in accordance with a Personalized Hearing Level (PHL).

The earpiece 90 can generate an Ear Canal Transfer Function (ECTF) to model the ear canal 124 using ECR 114 and ECM 106, as well as an Outer Ear Canal Transfer function (OETF) using ASM 120. For instance, the ECR 114 can deliver an impulse within the ear canal 124 and generate the ECTF via cross correlation of the impulse with the impulse response of the ear canal 124. The earpiece 90 can also determine a sealing profile with the user's ear to compensate for any leakage. It also includes a Sound Pressure Level Dosimeter to estimate sound exposure and recovery times. This permits the earpiece 90 to safely administer and monitor sound exposure to the ear.

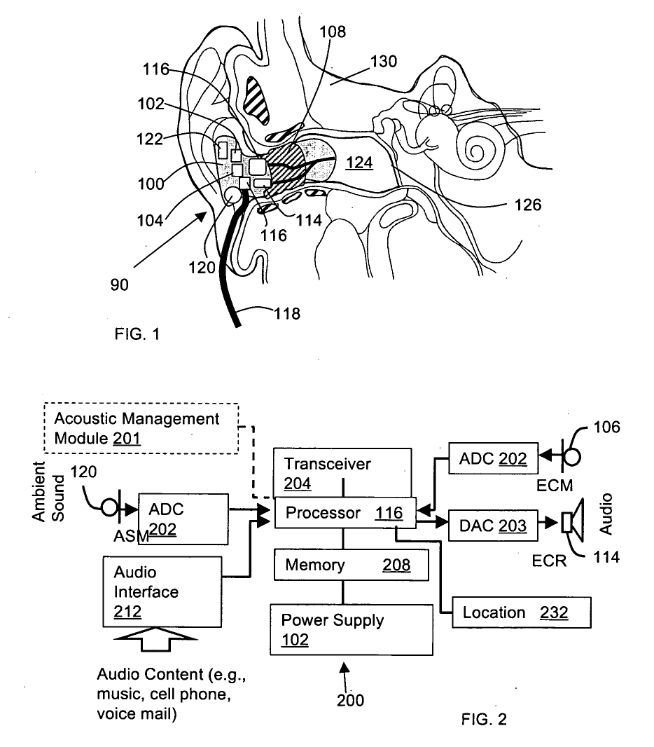

Referring to FIG. 2, a block diagram 200 of the earpiece 90 in accordance with an exemplary embodiment is shown. As illustrated, the earpiece 90 can include the processor 116 operatively coupled to the ASM 120, ECR 114, and ECM 106 via one or more Analog to Digital Converters (ADC) 202 and Digital to Analog Converters (DAC) 203. The processor 116 is configured operatively with storage memory 208 whereby storage memory 208 can be a Flash, ROM, RAM, SRAM, DRAM or other storage methods as know by one of ordinary skill. The processor 116 can also include a clock to record a time stamp.

As illustrated, the earpiece 90 can include an acoustic management module 201 to mix sounds captured at the ASM 111 and ECM 123 to produce a mixed sound. The processor 116 can then provide the mixed signal to one or more subsystems, such as a voice recognition system, a voice dictation system, a voice recorder, or any other voice related processor or communication device. The acoustic management module 201 can be a hardware component implemented by discrete or analog electronic components or a software component. In one arrangement, the functionality of the acoustic management module 201 can be provided by way of software, such as program code, assembly language, or machine language.

The memory 208 can also store program instructions for execution on the processor 116 as well as captured audio processing data and filter coefficient data. The memory 208 can be off-chip and external to the processor 208, and include a data buffer to temporarily capture the ambient sound and the internal sound, and a storage memory to save from the data buffer the recent portion of the history in a compressed format responsive to a directive by the processor. The data buffer can be a circular buffer that temporarily stores audio sound at a current time point to a previous time point. It should also be noted that the data buffer can in one configuration reside on the processor 116 to provide high speed data access. The storage memory can be non-volatile memory such as SRAM to store captured or compressed audio data.

The earpiece 90 can include an audio interface 212 operatively coupled to the processor 116 and acoustic management module 201 to receive audio content, for example from a media player, cell phone, or any other communication device, and deliver the audio content to the processor 116. The processor 116 is responsive to detecting spoken voice from the acoustic management module 201 and can adjust the audio content delivered to the ear canal. For instance, the processor 116 (or acoustic management module 201) can lower a volume of the audio content responsive to detecting a spoken voice. The processor 116 by way of the ECM 106 can also actively monitor the sound exposure level inside the ear canal and adjust the audio to within a safe and subjectively optimized listening level range based on voice operating decisions made by the acoustic management module 201.

The earpiece 100 can further include a transceiver 204 that can support singly or in combination any number of wireless access technologies including without limitation Bluetooth™, Wireless Fidelity (WiFi), Worldwide Interoperability for Microwave Access (WiMAX), and/or other short or long range communication protocols. The transceiver 204 can also provide support for dynamic downloading over-the-air to the earpiece 90. It should be noted also that next generation access technologies can also be applied to the present disclosure.

The location receiver 232 can utilize common technology such as a common GPS (Global Positioning System) receiver that can intercept satellite signals and therefrom determine a location fix of the earpiece 90.

In at least one exemplary embodiment, the power source (e.g., battery) 102 can be a rechargeable or replaceable battery but more generally it can be a power source utilizing common power management technologies such as supply regulation technologies, and charging system technologies for supplying energy to the components of the earpiece 90 and to facilitate portable applications. A motor (not shown) can be a single supply motor driver coupled to the power supply 210 to improve sensory input via haptic vibration. As an example, the processor 116 can direct the motor to vibrate responsive to an action, such as a detection of a warning sound or an incoming voice call.

The earpiece 90 can further represent a single operational device or a family of devices configured in a master-slave arrangement, for example, a mobile device and an earpiece. In the latter embodiment, the components of the earpiece 90 can be reused in different form factors for the master and slave devices.

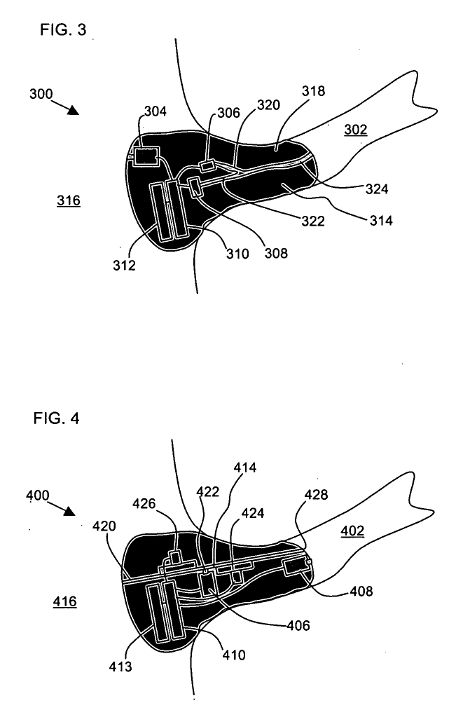

Referring to FIG. 3, an earpiece 300 is illustrated which can seal an ear canal 302 of a user. Earpiece 300 can include an Ambient Sound Microphone (ASM) 304, an Ear Canal Microphone (ECM) 306, an Ear Canal Receiver (ECR) 308, a microprocessor 310, a power source 312, an acoustic channel 314, and a sealing section 318. ECM 306 and ECR 308 are acoustically coupled to ear canal 302 which is a first volume. ASM 304 is acoustically coupled to an ambient region 316 which is a second volume. Sealing section 318 comprises a portion of earpiece 300 placed in the ear canal. Sealing section 318 is an acoustic barrier between the first volume (ear canal 302) and the second volume (ambient region 316). In general, sealing section 318 isolates ear canal 302 from the ambient and attenuates or blocks acoustic sounds in ambient region 316 from passing into ear canal 302.

In an exemplary embodiment, acoustic channel 314 is a single or common acoustic channel that acoustically couples ECM 306, ECR 308, and ear canal 302 together. For example the acoustic channels from ECR 308 and from ECM 306 can combine a distance into a common channel 314, for example 10 mm along their lengths. Acoustic channel 314 comprises a first channel portion 320, a second channel portion 322, and a third channel portion 324. ECM 306 is operatively coupled to a port of first channel portion 320 for receiving an acoustic signal. ECR 308 is operatively coupled to a port of second channel portion 322 for delivering an acoustic signal. Third channel portion 324 operatively couples to first channel portion 320 and second channel 322 and extends through sealing section 318 exposing a port that is acoustically coupled to ear canal 302.

Having a common acoustic channel for ECR 308 and ECM 306 to ear canal 302 removes the need for structurally separated acoustic transmission channels as used in conventional devices. Dimensionally, acoustic channel 314 is typically less than 3 mm in diameter. The length from port to ear canal port of the acoustic channel 314 is dependent on the design of housing of earpiece 300 but is in a range of 15-20 mm in length for some designs. In an exemplary embodiment, third channel portion 324 of acoustic channel 314 is the only acoustic tube in sealing section 318 of earpiece 300. Having only third channel portion 324 in sealing section 318 aids in keeping the cross-section of earpiece 300 to a minimum, allowing closer placement toward the eardrum thereby increasing performance. Note that acoustic channel 314 allows the placement of ECM 306 and ECR 308 away from a narrow portion of ear canal 302 where there is increased space for the components. Moreover, acoustic channel 314 simplifies manufacture of earpiece 300 and lowers cost.

In an exemplary embodiment, first channel portion 320 is formed at an acute angle with second portion 322. Both ECR 308 and ECM 306 are acoustically coupled to ear canal 302. Processor 310 is operatively coupled to ECR 308 and ECM 306. Processor 310 provides audio content in the form of an electrical signal to ECR 308. ECR 308 converts the electrical signal to an acoustic signal that is provided to acoustic channel 314. The acoustic signal generated by ECR 308 propagates through acoustic channel 314 and into ear canal 304.

ECM 306 is acoustically coupled to both ECR 308 and ear canal 302. Thus, ECM 306 receives a combination or mixture of acoustic signals from ear canal 302 and ECR 308. As mentioned previously, processor 310 is operatively coupled to ECM 306. ECM 306 measures acoustic content in ear canal 302 and converts the acoustic content to an electrical signal provided to processor 310. Processor 310 can process and use the audio content as is common in an earpiece such as providing speech to the user, speech detection, echo cancellation, measuring sound level, and mixing with other audio content.

ASM 304 is located in earpiece 300 to acoustically couple to ambient region 316. Processor 310 is operatively coupled to ASM 304. ASM 304 measures acoustic content in ambient region 316 and converts the acoustic content to an electrical signal provided to processor 310. Processor 310 can process the audio content from ear canal 302, ambient region 316, and other inputs (portable media player, cell phone, other earpieces, etc. . . . ) to provide to the user through ECR 308. For example, if the user is speaking, processor 310 can control the mix of the acoustic signals received from ambient region 316 and ear canal 302 sent to a communication device such as a cell phone for transmission.

Referring to FIG. 4, a diagram of an earpiece 400 is illustrated having a single acoustic channel 414. Earpiece 400 includes a transducer 406, an Ear Canal Receiver (ECR) 408, a microprocessor 410, a power source 412, an acoustic channel 414, and a sealing section 418. Earpiece 400 is shown fitted in the ear of the user thereby sealing or partially sealing ear canal 402. As disclosed hereinabove, sealing section 418 isolates ear canal 402 and attenuates or blocks acoustic sounds in ambient region 416 from passing into ear canal 402 (and vice versa).

In an exemplary embodiment, acoustic channel 414 is a single or common acoustic channel for acoustic coupling ambient region 416, ear canal 402, or both to transducer 406. Acoustic channel 414 includes a port 420, a port 422, and a port 428. Port 420 is located on earpiece 400 to acoustically couple to ambient region 416. Port 428 is located on sealing section 418 to acoustically couple to ear canal 402. ECR 408 is operatively configured to acoustically couple to port 422. In an exemplary embodiment, port 422 is located between port 420 and port 428.

Having a common acoustic channel 414 removes the need for a separate ear canal microphone and an ambient sound microphone that are used in conventional devices. Thus, a single microphone (transducer 406) is used in conjunction with acoustic channel 414 and more generally to earpiece 400. A mechanical device is used to block or partially block sections of acoustic channel 414 to direct acoustic coupling from one port to another. In an exemplary embodiment, a mems (micro-electrical mechanical system) actuator 424 and a mems actuator 426 are used to block or partially block portions of acoustic channel 414.

Actuator 424 (e.g., MEMS) and mems actuator 426 are a plunger type device operatively configured to block acoustic channel 414. Each mems actuator has a corresponding opening in acoustic channel 414 whereby the plunger mechanism couples through the opening to form a physical barrier within acoustic channel 414. More specifically, the plunger of a mems actuator is an acoustic barrier to an acoustic signal.

In an exemplary embodiment, the actuator 424 is placed between port 422 and port 428. Transducer 406 is acoustically coupled to ear canal 402 when the plunger of mems actuator 424 is fully retracted or partially blocks acoustic channel 414. Conversely, transducer 406 is acoustically decoupled from ear canal 402 when the plunger of actuator 424 is extended to block acoustic channel 414 between ports 422 and 428.

In an exemplary embodiment, actuator 426 is located on acoustic channel 414 between ports 420 and 422. Transducer 406 is acoustically coupled to ambient region 416 when the plunger of actuator 426 is fully retracted or partially blocks acoustic channel 414. Conversely, transducer 406 is acoustically decoupled from ambient region 416 when the plunger of actuator 426 is extended to block acoustic channel 414 between ports 420 and 422.

As mentioned previously, a single acoustic channel in sealing section 418 aids in keeping the cross-section of earpiece 400 to a minimum, allowing closer placement toward the eardrum to increase performance. Note that transducer 406, mems actuator 424, and actuator 426 can be placed away from a narrow portion of ear canal 402 where there is more space for components. Moreover, acoustic channel 414 simplifies manufacture of earpiece 400 and lowers cost by eliminating a second transducer.

Processor 410 is operatively coupled to transducer 406, ECR 408, and mems actuator 424 and actuator 426. Processor 410 provides audio content in the form of an electrical signal to ECR 408. ECR 408 converts the electrical signal to an acoustic signal provided to ear canal 402. The audio content can come from external components such as a media player or cell phone. Transducer 406 can also provide audio content to processor 410 from ambient region 416 or ear canal 402.

In one exemplary embodiment, transducer 406 is acoustically coupled to either ambient region 416 or ear canal 402 by blocking acoustic channel 414 with actuator 426 or mems actuator 424. In a first mode, transducer 406 measures acoustic content in ear canal 402 and converts the acoustic content to an electrical signal provided to processor 410. In a second mode of operation transducer 406 measures acoustic content in ambient region 416 and provides the content to processor 410.

In an exemplary embodiment, earpiece 400 is used for speech communication in full duplex mode via a cellular network with one or more people. The user and the other listeners would have difficulty hearing if user speech was sampled from ambient region 416 when background noise levels were high. In this situation, processor 410 actuates mems actuator 426 to block the acoustic path from ambient region 416 to transducer 406. Actuator 424 does not block acoustic channel 414. Thus, transducer 406 is acoustically coupled to ear canal 402. In this example, speech content in the ear canal 402 has a low background noise level in comparison to ambient region 416 and thus is more intelligible when transmitted to others or provided to the user through ECR 408. Speech received from ear canal 402 may lack some high frequency characteristics as is well known to one skilled in the art when compared to speech transmitted from the mouth and into the ambient.

In another exemplary embodiment of providing user speech, processor 410 actuates actuator 424 when background noise level is low in ambient region 416. Actuator 424 blocks the acoustic path from ear canal 402 to transducer 406. Actuator 426 does not block acoustic channel 414. User speech is provided from ambient region 416 through acoustic channel 414 to transducer 406. Using speech received from the ambient in a low background noise situation allows a more realistic sounding voice to be transmitted or provided to the user through ECR 408.

In a further exemplary embodiment of providing user speech, actuators 424 and 426 can be controlled with more precision than merely blocking or leaving open acoustic channel 414. Processor 410 is operatively configured to actuators 424 and 426 to adjust the depth of each plunger such that each actuator can restrict and vary the cross-sectional area of acoustic channel 414. Adjusting or varying an opening size in acoustic channel 414 restricts acoustic propagation through acoustic channel 414 thus affecting the acoustic energy reaching transducer 406. Actuators 424 and 426 can both be partially open allowing a combination of signals from ambient region 416 and ear canal 402 to be provided to transducer 406. The ratio of the energies received from ambient region 416 and ear canal 402 corresponds to the cross-sectional area created by actuators 424 and 426 in the area that they are located. In an exemplary embodiment, processor 410 controls actuators 424 and 426.

Additionally, a sampling approach could also be used between ambient region 416 and ear canal 402 to provide more realistic speech. In an exemplary embodiment, processor 410 switches between opening actuator 424/closing actuator 426 and closing actuator 424/opening actuator 426 at a selected frequency. As mentioned previously, the ratio of the relative energies received could also be adjusted by controlling plunger depth. The acoustic signals obtained and the energy ratio obtained can be used to add high frequency voice component to an otherwise attenuated voice pickup from ear canal 402 by adding a high frequency voice signal received from ambient region 416. For example the temporal acoustic signals can be placed into frequency space (e.g., using an FFT), where a noise band is filtered out, for example between 4000 Hz and 1000 Hz, where the acoustic energy received from ambient region 416 supplies a 4000 Hz and greater voice signal, while acoustic energy received from ear canal 402 supplies the 1000 Hz and less voice signal with the intervening frequencies 1000-4000 Hz supplied via an averaging algorithm. For example the averaging algorithm can be a persons recorded voice where the relative strength of the spectral powers in the range 1000 Hz to 4000 Hz are related by a ratio to the spectral powers outside the 1000 Hz to 4000 Hz range, or whatever range is selected to correspond to eth noise range.

Transducer 406 can be a speaker and a microphone. In an exemplary embodiment, transducer 406 would functionally replace ECR 408. Processor 410 would control when transducer 406 is utilized as a speaker and a microphone. Eliminating ECR 408 with transducer 406 simplifies the design of earpiece 400 and reduces component cost.

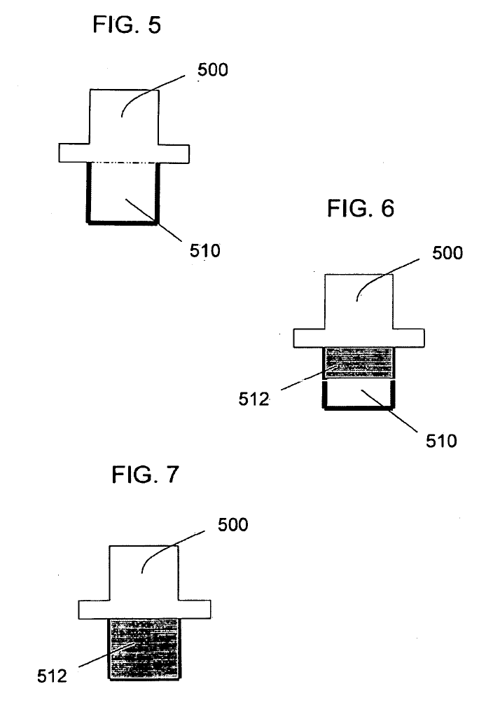

Referring to FIG. 5, a cross-section of a mems actuator 500 and an acoustic channel 510 is illustrated. Acoustic channel 510 is similar to acoustic channels described hereinabove. Mems actuator 500 is operatively configured to variably control a cross-sectional area of acoustic channel 510. In an exemplary embodiment, a plunger (not shown) is withdrawn into mems actuator 500 such that acoustic channel 510 has a maximum cross-sectional area.

Referring to FIG. 6, a cross-section of mems actuator 500 and acoustic channel 510 is illustrated where the channel is partially blocked. In an exemplary embodiment, the plunger extends into acoustic channel 510. The plunger only partially extends into acoustic channel 510 reducing the cross-sectional area of acoustic channel 510 in the region where mems actuator 500 resides. Reducing the cross-sectional area attenuates and modifies how an acoustic signal propagates through acoustic channel 510.

Referring to FIG. 7, a cross-section of mems actuator 500 and acoustic channel 510 is illustrated where the channel is fully blocked. In an exemplary embodiment, the plunger extends fully into acoustic channel 510. The channel of acoustic channel 510 is completely blocked by the plunger of mems actuator 500. The plunger is an acoustic barrier to an acoustic signal propagating through acoustic channel 510.

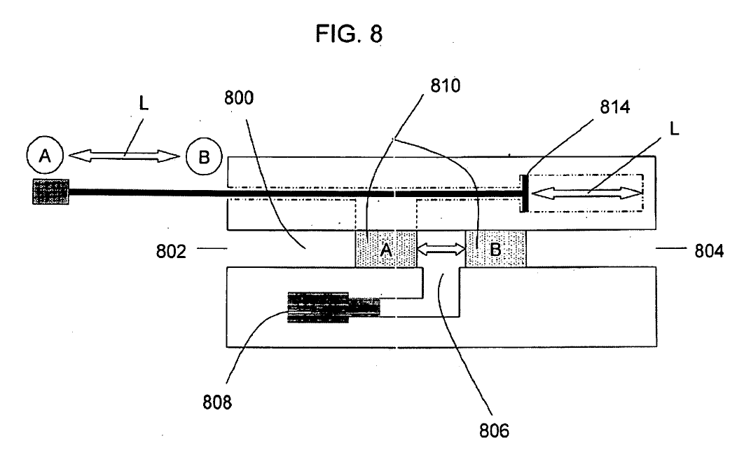

Referring to FIG. 8, a longitudinal cross-section of an acoustic channel 800 is illustrated. Acoustic channel has a port 802, a port 804, and a port 806. A transducer 808 is operatively coupled to port 806 for providing or receiving an acoustic signal. In an exemplary embodiment, a sliding plug 810 in acoustic channel 800 acoustically decouples port 802 or port 804 from transducer 808. A rod 812 is connected to sliding plug 810. Rod 812 controls movement and location of sliding plug 810. A flange 814 formed on a distal end of rod 812 is fitted in a cylinder having a length “L” as shown on the diagram. The total travel of rod 812 is limited to the length L.

In a first mode of operation, flange 814 is stopped at a first end of the cylinder. This corresponds to a position A as indicated on rod 812 and sliding plug 810. In position “A”, sliding plug 810 is an acoustic barrier between port 802 and port 806. Conversely, an acoustic path exists from port 804 to port 806 (and transducer 808).

In a second mode of operation, rod 812 is moved until flange 814 is stopped at a second end of the cylinder. This corresponds to a position “B” as indicated on rod 812 and sliding plug 810. In position B, sliding plug 810 is an acoustic barrier between port 804 and port 806. Conversely, an acoustic path exists from port 802 to port 806 (and transducer 808).

Rod 812 can be manually positioned to position A or B. Rod 812 could also be motivated to be moved back and forth by a mechanical or electro-mechanical means. For example, a solenoid type device pulling and pushing on rod 812. In an exemplary embodiment, acoustic channel 800 can be used to acoustically couple a transducer to either an ambient region or an ear canal as described in FIG. 4.

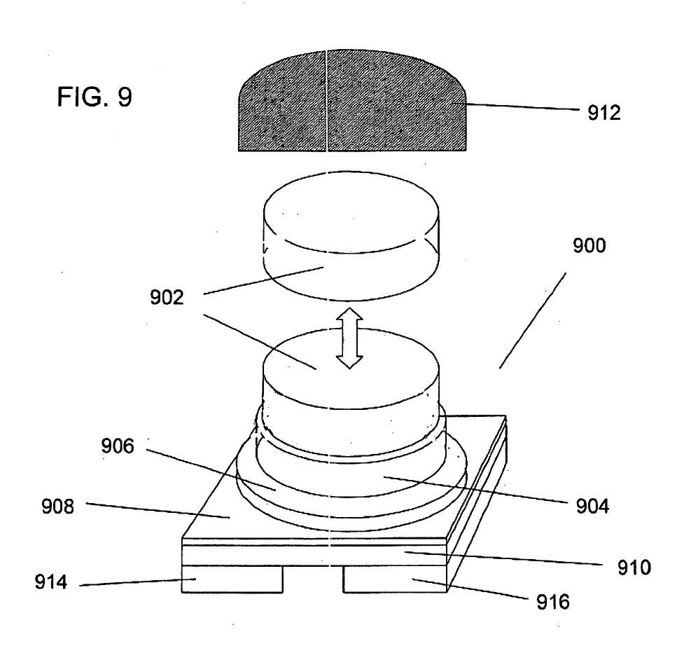

Referring to FIG. 9, a battery replacement module 900 is provided for simplifying replacement in an earpiece. In an exemplary embodiment, a battery 902 is secured via a magnetic force to battery replacement module 900 (also called a battery holder). Battery 902 has a first electrode on a first major surface and a second electrode on a sidewall and second major surface. Battery replacement module 900 comprises a retaining ring 904, a base 906, a μ-metal shield 908, a base 910, a cap 912, an electrode 914, an electrode 916, and a magnet 918.

Retaining ring 904 has a diameter similar to a battery 902. Retaining ring 904 helps a user align battery 902 to battery holder 900. Retaining ring 904 can be made of conductive material or have conductive contacts for connecting to the second electrode of battery 902. In an embodiment of battery replacement module 900, retaining ring 904 can be formed with base 906. A sidewall surface of base 906 is an interference fit with cap 912. Cap 912 fits over and covers battery 902. Cap 912 can also provide pressure on battery 902 for ensuring good electrical contact to interconnect of battery replacement module 900.

Base 910 includes a magnet 918 (not shown) for using magnetic force to hold battery 902 in place as well as providing a force for holding electrodes in contact with electrical interconnect. A first interconnect couples through base 910 (not shown) and electrically connects the first electrode of battery 902 to electrode 916. A second interconnect couples through and connects the second electrode of battery 902 (through base 906/retaining ring 904) to electrode 914. The μ-metal shield 908 overlies base 910 to provide a barrier to magnetic fields and prevents magnet 918 from influencing other components in the earpiece.

As shown, electrodes 914 and 916 can be soldered to a printed circuit board in an area of easy access within an earpiece. Magnet 918 simplifies the installment of a battery which in some earpieces, for example, hearing aids can occur weekly. Elderly people often have trouble manipulating small objects. Battery replacement module 900 allows one to simply put the battery proximate to the holder and the magnetic force and retaining ring attract and align the battery for installation.

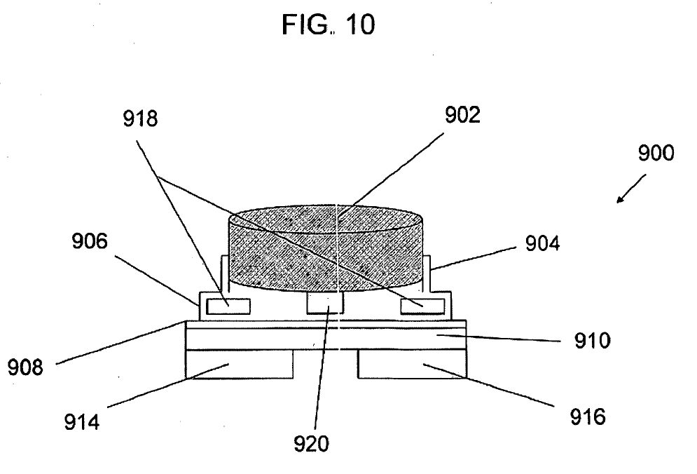

Referring to FIG. 10, a cross-section of battery replacement module 900 is illustrated. In an exemplary embodiment, magnet 918 is shown in base 906. Magnet 918 is circular in shape thereby symmetrically pulling on battery 902. An interconnect 920 is shown centrally located in base 906 for connecting to the first electrode of battery 902.

In general, the technique for magnetically coupling components together for battery replacement module 900 can be extended to other areas of an earpiece. For example, a wire connection to an earpiece (or earbud) is common in a device for listening to music. The wire if caught on an object or pulled by accident can be dangerous for a device having a component that is inserted in the ear canal. Magnetically coupling the wire to the earpiece via magnets would allow good electrical connection and safety. Pulling on the wires would break the magnetic connection thereby physically decoupling the connection without disturbing the earpiece fitted in the user's ear.

Similarly, earpieces have several other components for retaining or holding the device on the ear. Components of the earpiece can be made to detach for safety and magnetically secure back together for ease of placing on or in ear of the user. Moreover, additional components for special applications could be added to the earpiece for a period of time when required and then easily removed when finished. The magnetic interface would provide both electrical and physical connection to the earpiece.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

What is claimed is:

1. An earpiece comprising:
a microphone;
an acoustic channel;
a selective attenuation mechanism;
a speaker; and
a logic circuit, where the microphone, the acoustic channel, the speaker, the selective attenuation mechanism, and the logic circuit are operatively coupled in an earpiece, where the microphone is configured to sample an acoustic signal traveling from either end of the acoustic channel, where the selective attenuation mechanism is configured to select from which end of the acoustic channel the acoustic signal reaches the microphone.

2. The earpiece of claim 1 where a first end of the acoustic channel is configured to acoustically couple to an ear canal of the user of the earpiece and where a second end of the acoustic channel is configured to acoustically couple to an ambient environment.

3. The earpiece of claim 2 where the speaker is configure to acoustically couple to the ear canal of the user of the earpiece.

4. The earpiece of claim 1 where the selective attenuation mechanism is a channel plug device for variable blocking of the acoustic channel.

5. The earpiece of claim 1 where the selective attenuation mechanism is a linear actuator for variable blocking of the acoustic channel.

6. The earpiece of claim 1 where the selective attenuation mechanism comprises a rotatable cover on each end of the acoustic channel.

7. An earpiece comprising:
a first microphone;
a second microphone;
a speaker;
an acoustic channel; and
a logic circuit, where the first and second microphones, the acoustic channel, the speaker, and the logic circuit are operatively coupled in an earpiece, where the first microphone is configured to sample an acoustic signal traveling from an ambient region, where the second microphone is configured to sample an acoustic signal traveling from an ear canal region, where the receiver is configured to emit acoustic signals into the ear canal region, where the second microphone and the receiver are connected to the acoustic channel which is configured to receive acoustic signals from the ear canal region.

8. An earpiece comprising;
an acoustic channel having at least three ports;
a microphone coupled to a first port of the acoustic channel; and
a selective attenuation mechanism operatively coupled to the acoustic channel, the selective attenuation mechanism is configured to couple and decouple the microphone from at least one of the two remaining ports.

9. The earpiece of claim 8 further including:
a speaker coupled to a second port of the acoustic channel and
a second microphone configured for acoustic coupling to an ambient environment.

10. The earpiece of claim 9 where the third port of the acoustic channel is configured to acoustically couple to an ear canal of the user.

11. The earpiece of claim 10 where the selective attenuation mechanism is operatively configured to couple and decouple the speaker from the third port.

12. The earpiece of claim 8 where a second port of the acoustic channel is configured to acoustically couple to an ear canal of the user and where a third port of the acoustic channel is configured to acoustically couple to an ambient region.

13. The earpiece of claim 12 where the selective attenuation mechanism is operatively configured to vary a relative acoustic energy received by the microphone from the ambient region.

14. The earpiece of claim 12 where the selective attenuation mechanism is operatively configured to vary a relative acoustic energy received by the microphone from the ear canal.

15. The earpiece of claim 8 where the selective attenuation mechanism can vary a cross-sectional area of the acoustic channel.

16. The earpiece of claim 8 further including:
a sealing section operatively configured for sealing an orifice of a user of the earpiece; and
a processor operatively coupled to the microphone and to the selective attenuation mechanism.

17. An earpiece comprising:
at least one microphone;
at least one speaker;
a processor operatively coupled to the at least one microphone and at least one speaker; and
a battery holder where the battery holder includes a magnet.

18. The earpiece of claim 17 further including a battery where the magnet provides a magnetic force for holding the battery in the battery holder.

19. The earpiece of claim 17 where the battery holder further includes:
a retaining ring for aiding in positioning the battery in the battery holder;
a base underlying the retaining ring where the magnet is formed in the base;
a first electrode underlying the base of the battery holder;
a second electrode underlying the base of the battery holder; and
interconnect coupling the first electrode of the battery to the first electrode of the battery holder and coupling the second electrode of the battery to the second electrode of the battery holder.

20. The earpiece of claim 19 further including a magnetic shield layer underlying the base.
